(19) United States
(12) Patent Application Publication
(10) Pub. No.: US 2020/0062112 A1
(43) Pub. Date: Feb. 27, 2020

(54) TANDEM AXLE WITH DISCONNECT COAST

(71) Applicant: DANA HEAVY VEHICLE SYSTEMS GROUP, LLC, MAUMEE, OH (US)

(72) Inventors: ANDREW T. BRAMMER, TOLEDO, OH (US); MARK A. DAVIS, KALAMAZOO, MI (US); GEORGE A. WILLFORD, WATERVILLE, OH (US)

(73) Assignee: DANA HEAVY VEHICLE SYSTEMS GROUP, LLC, MAUMEE, OH (US)

(21) Appl. No.: 16/500,518

(22) PCT Filed: May 3, 2018
(86) PCT No.: PCT/US2018/030790

§ 371 Date: Oct. 3, 2019

Related U.S. Application Data
(60) Provisional application No. 62/500,585, filed on May 3, 2017.

(51) Int. Cl. B60K 17/36; B60W 10/04; B60W 10/14; B60W 30/18

(52) U.S. Cl. CPC B60K 17/36; B60W 10/04; B60W 10/14; B60W 30/18072; B60W 2710/125; B60W 2510/0657; B60W 2520/28; B60W 2520/30; B60W 2030/18081

(57) ABSTRACT

Provided herein is a method of disconnecting and connecting elements of a tandem axle system (100) drivingly connected to an engine (206) and transmission (204) of a vehicle, the method including the steps of: providing a tandem axle system (100) having: an inter-axle differential and clutch assembly (102) in driving engagement with the engine, wherein the inter-axle differential and clutch assembly includes an inter-axle differential (108) and an inter-axle differential lock (110); a forward axle assembly (104) including a differential assembly (116), a disconnect assembly (114) and two axle half shafts (104a, 104b); and a rear axle assembly (106) including a differential assembly (120), a disconnect assembly (122) and two axle half shafts (106a, 106b); providing a control system (300) in communication with the inter-axle differential lock, the disconnect assemblies and the engine; detecting (402) a disconnect opportunity; commanding (404) the engine torque set to zero; disconnecting (406) the axle half shafts of the forward and rear axle assemblies; engaging (408) the inter-axle differential lock; and allowing (410) the engine to idle.

### RELATED APPLICATION

The present application claims the benefit of U.S. Provisional Application No. 62/500,585, filed May 3, 2017, which is incorporated herein by reference in its entireties.

### BACKGROUND

Tandem axle assemblies are widely used on trucks and other load-carrying vehicles. The tandem axle assembly typically includes a forward axle and a rear axle. Typically both axles are driven, in some cases only one axle is driven. The tandem axle assembly may be designated a 6×4 tandem axle assembly when the forward axle and the rear axle are drivingly engaged. The tandem axle assembly may be designated a 6×2 tandem axle assembly when either one of the forward axle and the rear axle is drivingly engaged.

Many tandem axle assemblies disconnect vehicle transmissions when coasting to increase fuel economy. Currently, an automatic transmission is placed into neutral when a vehicle is coasting to reduce driveline losses and improve fuel economy. This requires additional hardware or software increasing the cost and complexity of the system.

Therefore, there is a need for a method to disconnect connect components of the tandem axle assembly to provide an increased fuel economy. It can be appreciated that when an axle is disconnected from the driveline, power losses decrease, thus increasing the driveline efficiency. The method described herein provides a greater driveline efficiency can be achieved by disconnecting the axle shafts of one or both the forward and rear tandem drive axles in coast condition.

### SUMMARY

Provided herein is a method of disconnecting and connecting elements of a tandem axle system drivingly connected to an engine and transmission of a vehicle, the method including the steps of: providing a tandem axle system having: an inter-axle differential and clutch assembly in driving engagement with the engine, wherein the inter-axle differential and clutch assembly includes an inter-axle differential and an inter-axle differential lock; a forward axle assembly including a differential assembly, a disconnect assembly and two axle half shafts, wherein the disconnect assembly selectively connects the axle half shafts to the differential assembly; and a rear axle assembly including a differential assembly, a disconnect assembly and two axle half shafts, wherein the disconnect assembly selectively connects the axle half shafts to the differential assembly; providing a control system in communication with the inter-axle differential lock, the disconnect assemblies and the engine; detecting a disconnect opportunity; commanding the engine torque set to zero; disconnecting the axle half shafts of the forward and rear axle assemblies; engaging the inter-axle differential lock; and allowing the engine to idle.

In some embodiments, a disconnect opportunity is detected when the vehicle has reached a predetermined cruise speed.

In some embodiments, a disconnect opportunity is detected when the vehicle has reached a predetermined torque limit.

In some embodiments, engaging the inter-axle differential lock occurs before disconnecting the axle half shafts of the forward and rear axle assemblies.

In some embodiments, engaging the inter-axle differential lock occurs simultaneously with disconnecting the axle half shafts of the forward and rear axle assemblies.

In some embodiments, the method further includes the steps of: detecting a reconnect opportunity; matching the rotational speeds across the axle half shafts of the forward and rear assemblies; reconnecting the axle half shafts of the forward and rear assemblies; disengaging the inter-axle differential lock; and returning control of the engine back to the operation of the vehicle.

In some embodiments, a reconnect opportunity is detected when the vehicle has slowed to a predetermined axle reconnect speed.

In some embodiments, a reconnect opportunity is detected when the vehicle has reached a predetermined torque limit.

### BRIEF DESCRIPTION OF THE DRAWINGS

The above, as well as other advantages of the present embodiments, will become readily apparent to those skilled in the art from the following detailed description when considered in the light of the accompanying drawings in which:

FIG. 1 is a schematic depiction of one embodiment of a tandem axle system;

FIG. 2 is a schematic depiction of one embodiment of a driveline including the tandem axle system of FIG. 1;

FIG. 3 is a schematic depiction of one embodiment of the method of disconnecting elements of a tandem axle system in a coast mode of operation;

FIG. 4 is a schematic depiction of another embodiment of the method of disconnecting elements of a tandem axle system in a coast mode of operation;

FIG. 5 is a schematic depiction of another embodiment of the method of reconnecting elements of a tandem axle system in a coast mode of operation;

FIG. 6 is a schematic depiction of another embodiment of the method of disconnecting elements of a tandem axle system in a coast mode of operation;

FIG. 7 is a schematic depiction of another embodiment of the method of disconnecting elements of a tandem axle system in a drive mode of operation; and

FIG. 8 a schematic depiction of another embodiment of the method of reconnecting elements of a tandem axle system in a drive mode of operation.

### DETAILED DESCRIPTION OF THE PREFERRED EMBODIMENTS

It is to be understood that the present embodiments may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless expressly stated otherwise.

The embodiments described herein relate to a tandem axle system and methods of operation thereof.

In particular, the method of using a control system to connect and disconnect element of a tandem axle system in a coast mode of operation to increase fuel efficiency.

In some embodiments, the tandem axle system has at least two axle assemblies wherein one of the axle assemblies can be selectively engaged/disengaged. Particularly the tandem axle system can be as disclosed in U.S. Pat. Nos. 8,523,738 and 8,911,321 hereby incorporated by reference. The above-referenced U.S. Pat. Nos. 8,523,738 and 8,911,321 disclose exemplary embodiments of a tandem axle system. However, it is understood the tandem axle system may include fewer or more assemblies or components or have various configuration.

FIG. 1 depicts one embodiment tandem axle system 100 that may be used with a control system 300 described herein. The tandem axle system 100 includes an inter-axle differential and clutching assembly 102, a forward axle assembly 104, and a rear axle assembly 106. The forward axle assembly 104 and the rear axle assembly 106 are in selective driving engagement with the inter-axle differential and clutching assembly 102.

In some embodiments, the axle of the rear axle assembly 106 and the axle of the forward axle assembly 104 are of different sizes depending on the functions assigned to each assembly.

In some embodiments, the inter-axle differential and clutching assembly 102 includes an inter-axle differential (IAD) 108 and an inter-axle differential lock 110. The IAD 108 is configured to split input torque between the forward axle assembly 104 and the rear axle assembly 106. In some embodiments, an input shaft 112 transfers torque from the driveline transmission to the IAD 108.

In some embodiments, a vehicle operator or control system 300 selectively engages and disengages the IAD lock 110 thereby overriding or disabling the IAD 108. In one embodiment, the IAD lock 110 is a sliding dog clutch that is activated using an actuator. In some embodiments, the actuator is a pneumatic actuator.

In some embodiments, the forward axle assembly 104 includes a differential assembly 116 and a disconnect assembly 114 as depicted in FIG. 1. The disconnect assembly 114 selectively connects the differential assembly 116 to axle half shafts 104a, 104b of the forward axle assembly 104.

In some embodiments, the forward axle assembly 104 includes a differential lock assembly 118.

In some embodiments, the rear axle assembly 106 includes a differential assembly 120 and a disconnect assembly 122 as depicted in FIG. 1. The disconnect assembly 122 selectively connects the differential assembly 120 to axle half shafts 106a, 106b of the rear axle assembly 106.

In some embodiments, the differential lock assembly 118 is located in the rear axle assembly 106.

In some embodiments, the differential lock assembly 118 is located in one of the forward or rear axle assemblies 104, 106, and the axle disconnect assembly is located in the other axle assembly.

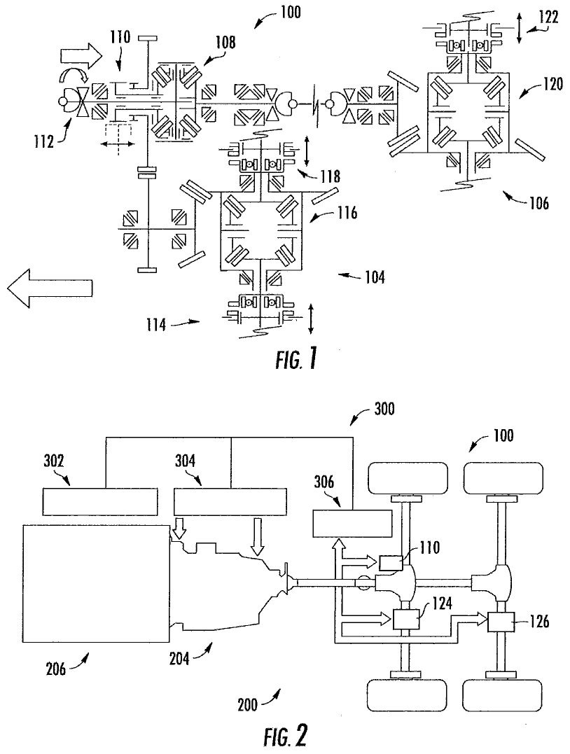

The disconnect assemblies 114, 122 are positioned on one axle shaft of each of the axle assemblies 104, 106, as shown in FIG. 2, and include a disconnect/reconnect clutch and an actuator. The actuator can be, but is not limited to, a pneumatic two-position actuator to operate the clutch. In some embodiments, an axle shaft has an axle disconnect/reconnect clutch similar in design to the differential lock clutch 118.

In some embodiments, the differential lock clutch 118 is operated by a pneumatic two-position actuator.

As illustrated in FIG. 2, the input shaft 112 of the tandem axle system 100 is part of a vehicle driveline 200.

In some embodiments, the tandem axle system 100 is drivingly connected to a transmission 204. The transmission 204 is drivingly connected to an engine 206 of the vehicle or other source of rotational power.

In some embodiments, the transmission 204 can be, but is not limited to, an automated manual transmission, a dual clutch transmission, an automatic transmission or a manual transmission.

In some embodiments, the vehicle includes a control system 300. The control system 300 allows an operator of a vehicle and/or the controller to control the tandem axle system 100.

In some embodiments, the control system 300 includes at least one controller and one or more sensors or a sensor array. The sensors can be intelligent sensors, self-validating sensors and smart sensors with embedded diagnostics. The controller is configured to receive signals and communicate with the sensors.

The one or more sensors are used to monitor performance of the driveline 200. The sensors can collect data from the driveline of the vehicle including, but not limited to, the torque and rotational speed of the axle half shafts. The speed of rotation and the torque are indicative of the speed of rotation and torque of the engine. In one embodiment, the sensors are mounted along the axle half shafts of the driveline 200, but can also be mounted elsewhere on the vehicle.

In one embodiment, the control system 300 includes additional discrete sensors beyond sensors already included in other components of the vehicle. In another embodiment, no additional sensors or sensed data relay systems are required beyond what are already included in the driveline 200.

In one embodiment, the control system 300 includes additional discrete sensors beyond sensors already included in other components of the vehicle. In another embodiment, no additional sensors or sensed data relay systems are required beyond what are already included in the driveline 200.

The control system 300 can also include a vehicle communication datalink in communication with the sensors and the controller. The sensors generate signals that can be directly transmitted to the controller or transmitted via the datalink or a similar network. In one embodiment, the controller can be integrated into an existing controller system in the vehicle including, but not limited to, an engine controller, a transmission controller, etc. or can be a discrete unit included in the control system 300. The controller may communicate a vehicle communication datalink message (comm. link J1939 or the like) to other components of the driveline 200 including, but not limited to, the engine.

In one embodiment, the controller is an electrical control unit (ECU). The ECU herein can be configured with hardware alone, or to run software, that permits the ECU to send, receive, process and store data and to electrically communicate with sensors, other components of the driveline 200 or other ECUs in the vehicle.

Additionally, the controller can include a microprocessor. The microprocessor is capable of receiving signals, performing calculations based on those signals and storing data received from the sensors and/or programmed into the microprocessor.

The control system 300 allows an operator of a vehicle and/or the controller to control the tandem axle system 100.

In some embodiments, the control system 300 includes an engine control unit 302, a transmission control unit 304 and an axle control unit 306. The control units 302, 304, 306 are in electronic communication with each other and a central controller (not shown).

The axle control unit 306 is in communication with the inter-axle differential lock 110, the differential lock 118 and the disconnect assemblies 114, 122.

The tandem axle system 100 has multiple modes of operation depending on the position of the inter-axle differential lock 110.

In some embodiments, the tandem axle system 100 may be placed in a 6×2 mode of operation or a 6×4 mode of operation. In the 6×4 mode of operation, both the forward axle assembly 104 and the rear axle assembly 106 are drivingly engaged with the input shaft 112 of the tandem axle system 100 through the IAD 108. In the 6×2 mode of operation, only the rear axle assembly 106 is drivingly engaged with the input shaft 112 of the tandem axle system 100 through the IAD 108 being placed in a locked condition (i.e. the IAD lock 110 is engaged) and the front axle assembly 104 is disconnected at the disconnect assembly 114.

By disconnecting one axle only or both axles along with the driveline 200 and placing the driveline 200 in a coast mode, the overall fuel economy of the driveline increases by reducing the frictional and rotational losses. The coast mode can be used in 4×2, 6×2, 8×2 single drive axle configurations and in 6×4, 8×4 or other tandem axle system drive configurations including low entry front, high entry front, and through shaft front configurations.

Elements of the tandem axle system 100 can be connected and disconnected from the driveline 200 when the system is placed into a coast mode using the control system 300.

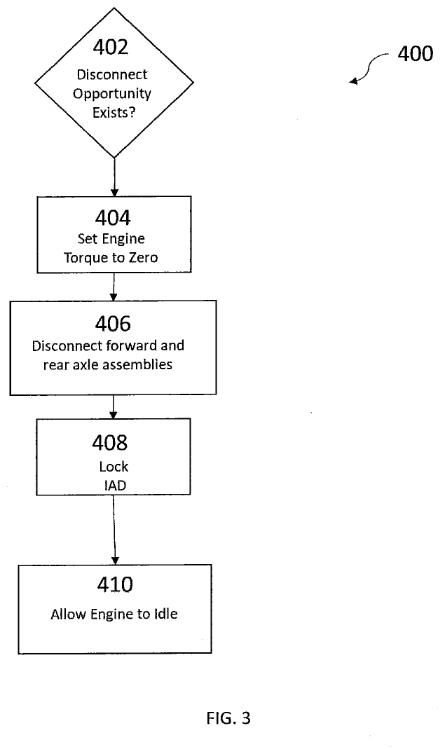

As shown in FIG. 3, in one embodiment, in a coast mode of operation, the control system 300 first determines if a driveline disconnect opportunity exists 402.

In some embodiments, the driveline disconnect opportunity determination is made by the control system 300 which receives signals from the control units 302, 304, 306 and/or operator to signal that a disconnect opportunity exist. The signal can be sent from axle control unit 306, the engine control unit 302 and/or the transmission control unit 304 or another part of the vehicle.

In some embodiments, a disconnect opportunity exists when the control system 300 receives signals from the control unit 302, 304, 306 showing that the vehicle has accelerated to a predetermined cruise speed, or torque requirements are below a threshold a predetermined threshold or engine braking is not anticipated or other key parameters of operation are met. If the data shows the requirements are below the predetermined thresholds, the driveline 200 can be floated (i.e. zero engine torque is provided) and the disconnect opportunity exists.

Once a disconnect opportunity has been detected, the control system 300 sends a signal to the engine 206 to go to zero torque set point 404. By setting the engine torque set point to zero, the control system 300 is floating the driveline 200.

Next, the control system 300 sends a signal to disconnect the forward and rear axle half shafts 406 by disengaging the disconnect clutches of the disconnect assemblies 114, 122.

Next the control system 300 sends a signal to lock the IAD 408. In some embodiments, the IAD 108 is locked using the inter-axle differential lock 110.

Finally, the engine 206 is allowed to spin down to an idle mode 410.

In some embodiments, the control system 300 returns engine control to the operator of the vehicle or other controller.

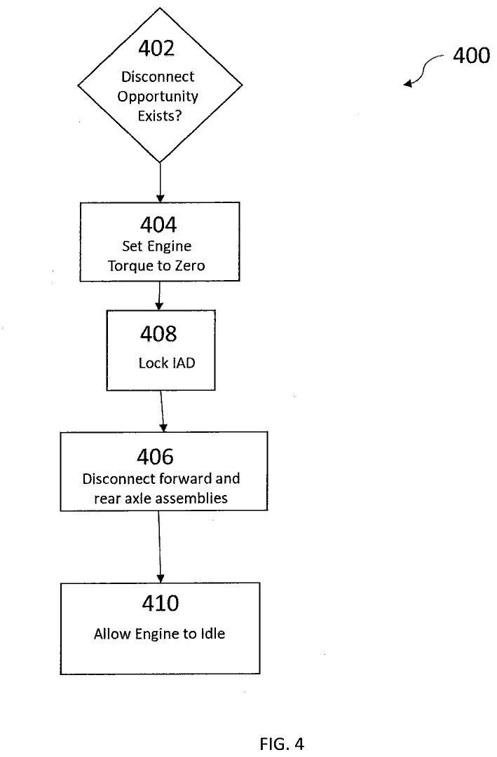

In some embodiments, the IAD 108 is locked before the forward and rear axles are disconnected using the disconnect assemblies 114, 122 as depicted in FIG. 4.

In some embodiments, the IAD 108 is locked simultaneously with the forward and rear axles being disconnected.

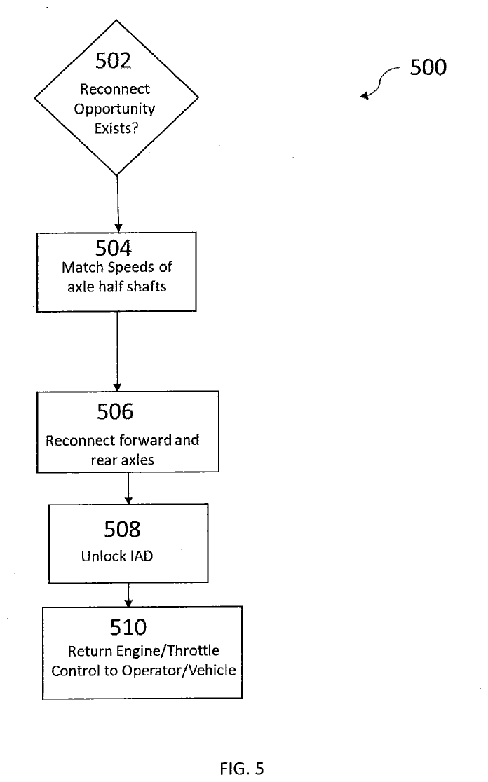

Once a vehicle is placed is a coast mode of operation and the axles disconnected, the system 100 can be reconnected when the control system 300 determines if a reconnect opportunity exists 502 using logic or receiving a reconnect signal from the control system 300 including, but not limited to, the engine control unit 302 and/or the transmission control unit 304 as shown in FIG. 5.

A reconnect opportunity exists when the control system 300 receives signals showing that vehicle has slowed to a predetermined axle reconnect speed or other key operation parameters such as torque meeting a predetermined threshold required.

If a reconnect opportunity exists, the control system 300 adjusts the rotational speeds across the axles and the disconnect assemblies 114, 122 so that they match 504. In some embodiments, the speed of the axles are matched by controlling the engine RPMs and matching the speed across the disconnect assemblies 114, 122 by monitoring the wheel speed by means of a wheel speed sensor or ABS wheel speed information.

Next, the control system 300 reconnects the axle shafts of the disconnected axle assembly or assemblies 506 and the IAD is unlocked 508.

In some embodiments, the axle shafts are reconnected using the disconnect assemblies 114, 122.

Once the axle shafts are reconnected, the control system 300 returns control of the engine back to the operator of the vehicle or controller for normal operation 510.

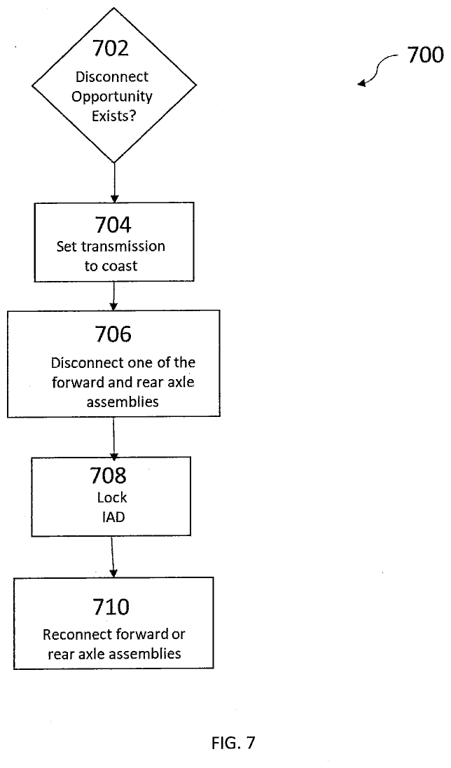

In another embodiment, the tandem axle system 100 utilizes the transmission 206 to start a coast mode of operation as shown in FIG. 7. In this method, the transmission is placed in neutral 704. Next, the axle half shafts of one of the forward or rear axle assemblies 104, 106 are disconnected using one of the disconnect assemblies 114, 122 as described above 706. Then, the IAD 108 is locked as described above 708.

In this mode of operation, only one of the forward or rear assemblies axle halft shafts are disconnected, which lowers the cost and complexity of the overall tandem system 100. Additionally, this mode of operation increases the efficiency provided by the neutral coast position of the transmission 206 by reducing the friction contribution from one axle.

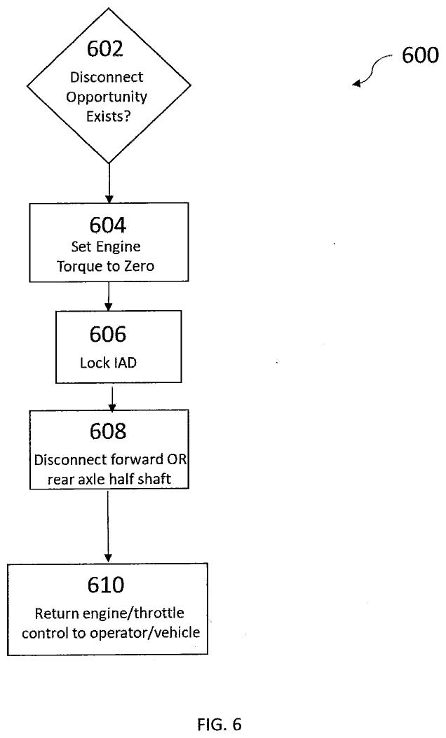

In some embodiments, the tandem axle system 100 provides additional efficiency by disconnecting the axle half shafts of one axle in a drive mode of operation by utilizing the existing disconnect assemblies 114, 122 and the IAD lock 110 and driving with one axle as shown in FIG. 6. In this mode of operation, the axle half shafts of one of the forward axle assembly 104 or rear axle assembly 106 are disconnected.

When the control system 300 detects a disconnect opportunity 602, the control system 300 commands a zero torque engine set point 604. Next the IAD is locked 606. Then the forward or rear axle half shafts are disconnected 608. Finally, the engine control is returned to the operation/vehicle 610.

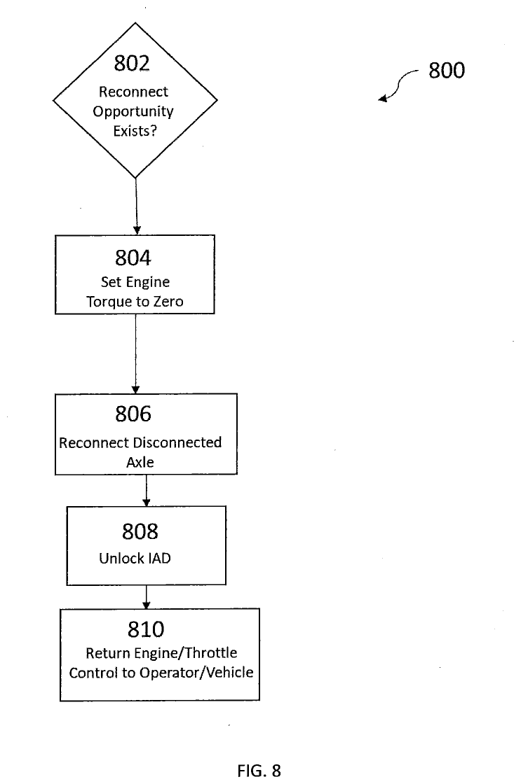

When the control system detects a reconnect opportunity 802, the control system 300 commands a zero torque engine set point 804, the disconnected axle half shafts are reconnected 806, the IAD is unlocked 808 and engine control is returned to the operator/vehicle 810 as depicted in FIG. 8.

By using the disconnect assemblies 114, 122 to stop the transmitting torque to the axle half shafts, the remaining components of the tandem axle system 100 are not required to stop rotating. Therefore, the time required to bring the system 100 up to the predetermined reconnect speed is reduced compared to systems where the other rotating components have come to a stop.

The drive mode axle disconnect method allows for two different size axles, front vs rear, depending on the functions assigned to each. This allows optimizing for fuel economy, weight, cost, etc. as an improvement over a tandem axle system that always has both axles engaged.

In some embodiments, the control system 300 receives additional information regarding the vehicle load and other operating characteristics, including information derived from other vehicle sensors, to determine if an axle assembly could be disconnected without exceeding the capacity of the remaining axle assembly.

In some embodiments, the tandem axle system 100 includes a mechanism for distributing weight between the forward and rear axle assemblies 104, 106. In some embodiments, the weight distribution mechanism is a permanent mechanism or a variable mechanism used to further increase efficiency by creating a weight bias when the axles are disconnected.

In accordance with the provisions of the patent statutes, the present disclosure has been described in what is considered to represent its preferred embodiments. However, it should be noted that the invention can be practiced otherwise than as specifically illustrated and described without departing from its spirit or scope.

Aspects of the invention described above include:

Aspect 1: A method of disconnecting and connecting elements of a tandem axle system drivingly connected to an engine and transmission of a vehicle, the method comprising the steps of:
providing a tandem axle system comprising:
   an inter-axle differential and clutch assembly in driving engagement with the engine, wherein the inter-axle differential and clutch assembly comprises an inter-axle differential and an inter-axle differential lock;
   a forward axle assembly comprising a differential assembly, a disconnect assembly and two axle half shafts, wherein the disconnect assembly selectively connects the axle half shafts to the differential assembly; and
   a rear axle assembly comprising a differential assembly, a disconnect assembly and two axle half shafts, wherein the disconnect assembly selectively connects the axle half shafts to the differential assembly;
providing a control system in communication with the inter-axle differential lock, the disconnect assemblies and the engine;
detecting a disconnect opportunity;
commanding the engine torque set to zero;
disconnecting the axle half shafts of the forward and rear axle assemblies;
engaging the inter-axle differential lock; and
allowing the engine to idle.
   Aspect 2. The method of Aspect 1, wherein a disconnect opportunity is detected when the vehicle has reached a predetermined cruise speed.
   Aspect 3. The method of Aspect 1, wherein a disconnect opportunity is detected when the vehicle has reached a predetermined torque limit/Aspect 4. The method of Aspect 1, wherein engaging the inter-axle differential lock occurs before disconnecting the axle half shafts of the forward and rear axle assemblies.
   Aspect 5. The method of Aspect 1, wherein engaging the inter-axle differential lock occurs simultaneously with disconnecting the axle half shafts of the forward and rear axle assemblies.
   Aspect 6. The method of Aspect 1 further comprising the steps of:
detecting a reconnect opportunity;
matching the rotational speeds across the axle half shafts of the forward and rear assemblies;
reconnecting the axle half shafts of the forward and rear assemblies;
disengaging the inter-axle differential lock; and
returning control of the engine back to the operation of the vehicle.
   Aspect 7. The method of Aspect 6, wherein reconnect opportunity is detected when the vehicle has slowed to a predetermined axle reconnect speed.
   Aspect 8. The method of Aspect 6, wherein reconnect opportunity is detected when the vehicle has reached predetermined torque limit.

1. A method of disconnecting and connecting elements of a tandem axle system drivingly connected to an engine and transmission of a vehicle, the method comprising the steps of:
providing a tandem axle system comprising:
an inter-axle differential and clutch assembly in driving engagement with the engine, wherein the inter-axle differential and clutch assembly comprises an inter-axle differential and an inter-axle differential lock;
a forward axle assembly comprising a differential assembly, a disconnect assembly and two axle half shafts, wherein the disconnect assembly selectively connects the axle half shafts to the differential assembly; and
a rear axle assembly comprising a differential assembly, a disconnect assembly and two axle half shafts, wherein the disconnect assembly selectively connects the axle half shafts to the differential assembly;
providing a control system in communication with the inter-axle differential lock, the disconnect assemblies and the engine;
detecting a disconnect opportunity;
commanding the engine torque set to zero;
disconnecting one or both of the axle half shafts of the forward and rear axle assemblies;
engaging the inter-axle differential lock; and
allowing the engine to idle.

2. The method of claim 1, wherein the disconnect opportunity is further detected when the vehicle has reached a predetermined cruise speed or the vehicle has reached a predetermined torque limit.

3. (canceled)

4. The method of claim 1, wherein the step of engaging the inter-axle differential lock occurs before disconnecting the axle half shafts of the forward and rear axle assemblies.

5. The method of claim 1, wherein the step of engaging the inter-axle differential lock occurs simultaneously with disconnecting the axle half shafts of the forward and rear axle assemblies.

6. The method of claim 1, further comprising the steps of:
detecting a reconnect opportunity;
matching rotational speeds of the axle half shafts of the forward and rear assemblies;
reconnecting the axle half shafts of the forward and rear assemblies;
disengaging the inter-axle differential lock; and
returning control of the engine back to the operator of the vehicle.

7. The method of claim 6, wherein the reconnect opportunity is detected when the vehicle has slowed to a predetermined axle reconnect speed or the vehicle has reached a predetermined torque limit.

8. (canceled)
